(19) United States
(12) Patent Application Publication
(10) Pub. No.: US 2025/0320039 A1
(43) Pub. Date: Oct. 16, 2025

(54) SLIDING LID WITH REMOVABLE PANELS FOR UTILITARY VEHICLE BOXES AND SIMILAR

(71) Applicant: Angel Gustavo Caro, Buenos Aires (AR)

(72) Inventor: Angel Gustavo Caro, Buenos Aires (AR)

(21) Appl. No.: 19/026,777

(22) Filed: Jan. 17, 2025

(30) Foreign Application Priority Data
Apr. 10, 2024 (AR) 20240100891

(51) Int. Cl. B65D 43/12

(52) U.S. Cl. CPC B65D 43/12; B65D 2543/00231

(57) ABSTRACT

Sliding cover with folding panels for utility vehicle boxes and similar, having three sliding panels, front, intermediate, and rear, of rectangular configuration and linked to each other by hinges. The intermediate and rear panels are also foldables. On the lower face of the panels, two support bases with wheels are fixed adjacent to their vertices. The support bases with wheels have two lower blocks. An external profile has a plurality of internal ribs and a horizontal wing is mounted on the upper edge of each side wall. An internal profile is joined to the external profile by a recess defined by a cavity formed at the end of a horizontal wing of the internal profile in which a lateral rib of the external profile is housed. The internal profile has a rolling channel. A drainage channel is formed in the internal profile.

### BACKGROUND OF THE INVENTION

The present invention relates to sliding lids, and more particularly, to a sliding lid with removable panels for utility vehicle boxes, which provides important advantages resulting from its easy assembly and disassembly in the boxes of the vehicles, regardless the configuration of the anti-roll bar of the same.

More specifically, this patent application relates to a sliding lid as described, which has been conceived and developed as a result of the experience acquired in the design, manufacture, and use of lids installed in utility vehicle boxes and similar, intended for the protection of luggage and objects transported therein, against theft and inclement weather. In this sense, the sliding cover with removable and fordable panels for utility vehicle boxes and similar of the present invention is quick and easy to disassemble and assemble, since no tools are necessary to carry out the operations. Likewise, the invented sliding lid can be used in the box of a utility vehicle that has a roll bar of any design because to the particular configuration of the elements used to support it. Once the sliding cover/lid is assembled, the box enclosure is perfectly insulated, ensuring effective protection of the transported objects against theft and inclement weather.

### PRIOR ART

In the state of the art, products for protecting stored luggage and objects in the rear box of utility vehicles are known. For example, tarpaulins or awnings are the most used, due to their low cost and ease of assembly and disassembly. However, a disadvantage of that product is the insecurity about the protection against theft, since it is extremely easy to break it with any sharp object.

Another inconvenient of the tarpaulins or awnings is the difficulty in achieving their tension, in order to avoid deformations that occur when rains or vehicle travels at high speeds.

Another product of the prior art intended to protect the load transported in the box of a utility vehicle, are rigid covers, which completely cover the upper part of the box, by one or more panels, so that by removing them down it is possible to access the inside of the box.

The inconvenient of this type of rigid covers is the complexity of their disassembly and assembly, since the covers are fixed to the box of the vehicle by anchoring elements that require the use of different tools to remove them or to fix them to the box of the vehicle.

Another problem of known rigid covers is that it is not always possible to mount them on the box of utility vehicles having a roll bar or cage. This is due to the fact that the roll bar or cage-adjacent to the rear of the cabin-and intended to protect the vehicle occupants, mainly in the event of a rollover, often has a structure that reduces the available width at the front end of the box, avoiding the mounting of the mentioned rigid covers.

The aforementioned disadvantages of known rigid covers are solved with the sliding cover with removable panels for utility vehicle boxes of the present invention, which can be mounted and dismounted from the vehicle box easily and quickly, without the need of tools, with the additional advantage of the possibility of mounting it on the box of any utility vehicle that has a roll bar or cage, regardless of the design or structural configuration thereof.

### SUMMARY OF THE INVENTION

The object of the present invention is a sliding cover with removable panels for utility vehicle boxes and the like, which comprises a plurality of panels linked together by hinges and which can be folded so that they are superimposed one on top of the other. The removable panels are rectangular in configuration and have support bases with wheels fixed adjacent to their vertices that allow them to slide. An external profile is mounted and fixed by anchors along the entire length of the upper edge of each of the side walls of the vehicle box, which is integrally connected by a socket to an internal profile, which forms the support element for the set of removable panels. The internal profile has a guide shaped like a channel, along which the wheels of the support bases of the removable panels rotate, so that they can easily slide backwards or forwards when they are manipulated by a person.

As can be seen, the sliding function of the removable panels of the invented cover allows them to be grouped one on top of the other and to place the set of panels in any position along the body of the vehicle, even under the roll bar or cage, in order to load or unload the transported objects.

Further objects of the invention will be brought out in the following part of the specification, wherein detailed description is for the purpose of fully disclosing the invention without placing limitations thereon.

### BRIEF DESCRIPTION OF DRAWINGS

With the above and other related objects in view, the invention consists in the details of construction and combination of parts as will be more fully understood from the following description, when read in conjunction with the accompanying drawings in which:

FIG. 1 represents a bottom plan view of the sliding lid with removable and foldable panels for utility vehicle boxes and similar.

FIG. 2 is a illustrates a rear elevation view of the external and internal profiles of the sliding lid with removable and foldable panels for utility vehicle boxes and similar.

FIG. 3 is a first perspective view of a portion of the external and internal profiles delimited by two transversal planes of the sliding lid with removable panels for utility vehicle boxes of the invention.

FIG. 4 is a second perspective view of a portion of the external and internal profiles delimited by two transversal planes of the sliding lid with removable panels for utility vehicle boxes

FIG. 5 is a perspective view of the portion of the external and internal profiles illustrated in FIGS. 3 and 4, and a support base with wheel, of the sliding lid with removable panels for utility vehicle boxes and similar.

FIG. 6 is a first bottom perspective view of a support base with wheel of the sliding lid with removable panels for utility vehicle boxes and similar.

FIG. 7 is a second bottom perspective view of the support base with wheel of the sliding lid with removable panels for utility vehicle boxes and similar.

FIG. 8 is a perspective view of the external and internal profiles and the wheeled support base of the sliding lid with removable and foldable panels for utility vehicle boxes and the like.

FIG. 9 is a rear elevation view of the sliding lid with removable and foldable panels for utility vehicle boxes and the like, mounted on the vehicle box.

### DETAILED DESCRIPTION OF THE INVENTION

Referring now to the drawings, the present invention is a sliding lid with removable panels for utility vehicle boxes and similar.

In all the figures, the same or equivalent parts or constituent elements of the example chosen for the present description correspond to the same reference numbers of the sliding lid with removable panels for utility vehicle boxes and similar.

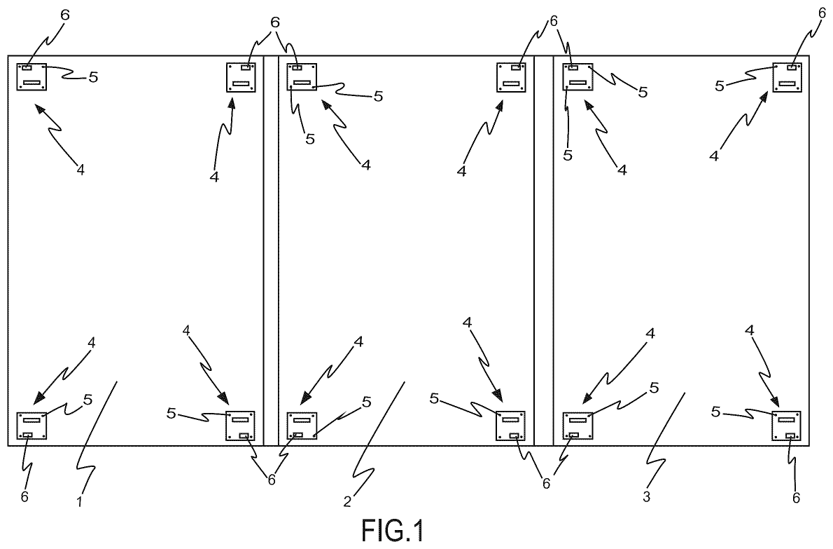

FIG. 1 is a bottom plan view of the invented sliding lid with removable panels showing the front panel 1, the intermediate panel 2, and the rear panel 3, all of rectangular configuration and linked together by hinges-not seen in the figure-. The front panel 1, adjacent to the vehicle cabin, is only sliding, while the intermediate panel 2 and the rear panel 3 are sliding and foldables.

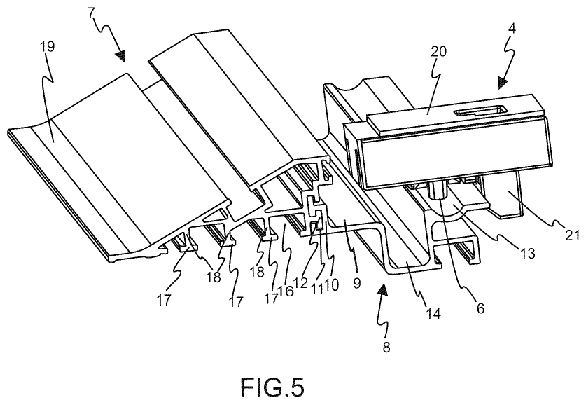

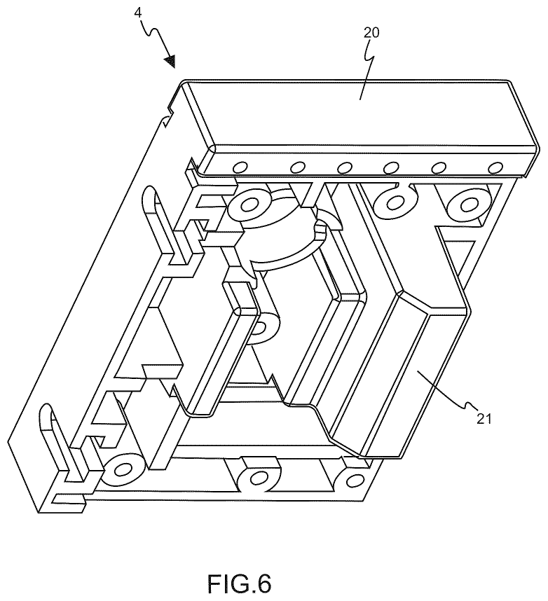

In the same figure, the support bases with wheels 4 are shown, fixed to the lower face of the panels adjacent to their vertices by screws 5. The support bases 4, formed by a hollow prismatic body, as seen in FIG. 6, have mounted inside them two wheels 6 that allow the panels to slide along the side walls of the vehicle box, as seen in FIG. 5.

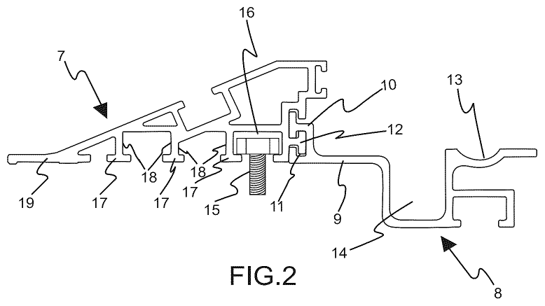

FIG. 2 is a rear elevation view of the external profile 7 and the internal profile 8 of the invented sliding lid with removable panels. In the position shown, the external profile 7 is mounted and fixed by a plurality of anchors, along the upper edge of the left side wall, not shown in the figure, of the vehicle box. Both profiles are metallic, preferably are made of extruded aluminum.

The internal profile 8 has the horizontal wing 9, whereby at the end 10 is the cavity 11 for housing the lateral rib 12 of the external profile 7, defining a socket that joins both profiles. This profile has the rolling channel 13 of cylindrical configuration, along which the wheels 6 of the support bases with wheels 4 rotate, as seen in FIG. 5. The drainage channel 14 of “U” configuration directs the water to the outside when the vehicle is splashed or is driving in the rain.

The screw 15 in the internal cavity 16 of the external profile 7 serves to anchor it to the left side wall-not illustrated in the figure-of the vehicle box. In total, at least three screws 15 are placed to anchor the external profile 7, along the left side wall of the vehicle box.

When assembling the profiles, the base 17 of the internal ribs 18 and the horizontal wing 19 of the external profile 7 rest on the upper edge of the left side wall, not shown in the figure, of the vehicle box.

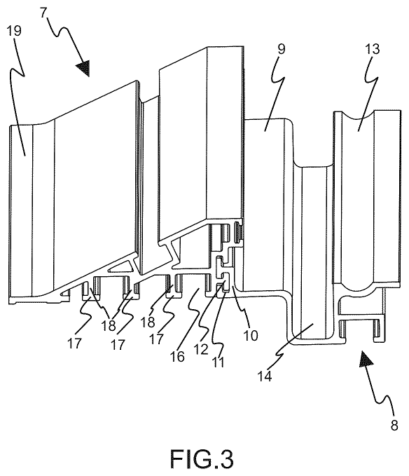

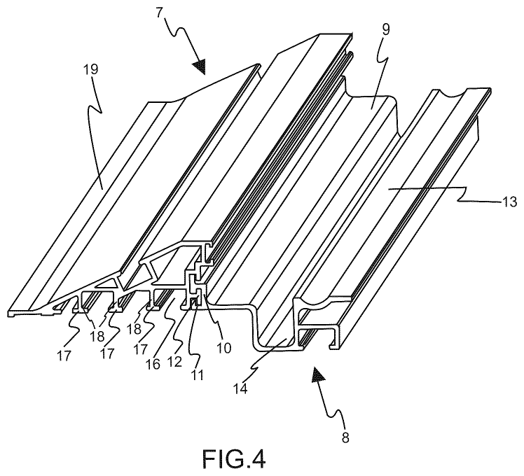

FIGS. 3 and 4 show perspective views of a portion of the external profile 7 and internal profile 8 delimited by two transversal planes, and in them the horizontal wing 9 of the internal profile 8 can be seen, in which end 10 is the cavity 11 for housing the lateral rib 12 of the external profile 7, defining the socket that cooperatively joins both profiles.

As mentioned, the internal profile 8 has the rolling channel 13 having a cylindrical configuration, on which the wheels 6 of the support bases with wheels 4 rotate, as seen in FIG. 5, and the drainage channel 14 having “U” configuration, intended to direct the water to the outside when the vehicle is splashed or circulates under the rain.

When assembling the profiles, the base 17 of the internal ribs 18 and the horizontal wing 19 of the external profile 7, rest on the upper edge of the left side wall, not illustrated in the figure, of the vehicle box.

FIG. 5 shows a perspective view of the portion of the external profile 7 and internal profile 8 illustrated in FIGS. 3 and 4, in which one of the support bases with wheel 4 can be seen. The support base, integrated with one of the panels, not illustrated in the figure, comprises a hollow prismatic body 20, made of injected plastic material, inside which the wheel 6 is mounted, which rotates along the rolling channel 13 when the panels, manipulated by a person, slide along the vehicle box.

In the same figure, the lower block 21 can be seen located adjacent to the rolling channel 13, which serves to guide the panel during its sliding.

As described and illustrated in FIG. 1, each of the three panels, front 1, intermediate 2 and rear 3, has four support bases with wheels 4, fixed to the lower face of the same, adjacent to their vertices. These support bases 4 and their respective wheels 6 allow the panels to slide along the side walls of the vehicle box, so that without the need to use tools it is possible to slide the panels backwards and fold the rear panel 3 over the intermediate panel 2 and the latter over the front panel 1. After this operation, the set of the stacked panels can be placed in any position in the vehicle box in order to load or unload the transported objects.

FIG. 6 represents a bottom perspective view of a support base with wheel 4 of the invented sliding lid with removable panels, in which the hollow prismatic body 20, made of injected plastic material, inside which the wheel 6 is mounted, not illustrated in the figure, and the lower block 21, which performs the function of guiding the panel during its sliding when it is manipulated by a person, can be seen.

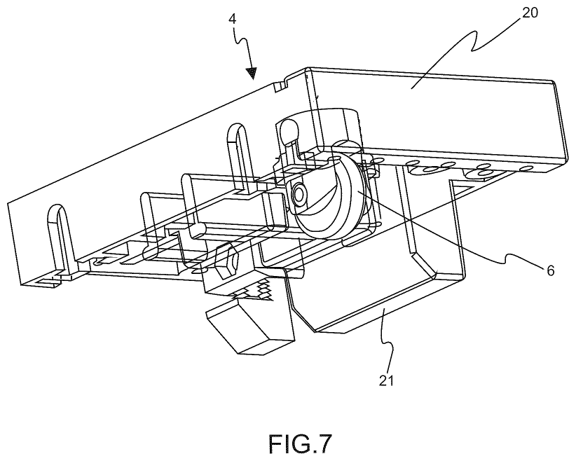

FIG. 7 shows another bottom perspective view of the support base with wheel 4 of the invented sliding lid with removable panels, in which the hollow prismatic body 20 inside which the wheel 6 is mounted, and the lower block 21, which serves the function of guiding the panel during its sliding when it is manipulated by a person, can be seen.

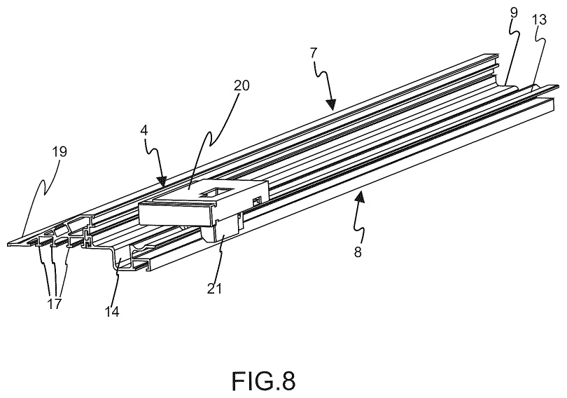

FIG. 8 represents a perspective view of the external profile 7 and the internal profile 8 and a support base with wheel 4 of the invented sliding lid with removable panels. In this figure, both profiles have the total length of the left side wall-not illustrated in the figure-of the vehicle box.

The horizontal wing 9 of the internal profile 8 can be seen, at whose end 10 is the cavity 11 for housing the lateral rib 12 of the external profile 7, defining the socket that cooperatively joins both profiles.

As mentioned, the internal profile 8 has the cylindrical rolling channel 13, on which the wheel 6 of the support base with wheel 4 rotates, and the drainage channel 14 of “U” configuration intended to direct the water to the outside when the vehicle is splashed or circulates under the rain.

The same figure show the base 17 of the internal ribs 18 and the horizontal wing 19 of the external profile 7, which rest on the upper edge of the left side wall, not illustrated in the figure, of the vehicle box, when the profile is mounted and anchored on it.

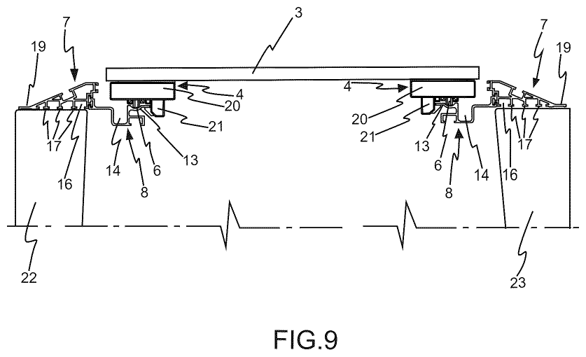

FIG. 9 illustrates a rear elevation view of the invented sliding lid with removable panels for utility vehicle boxes and similar, mounted on the left side wall 22 and right side wall 23 of the vehicle box.

The rear panel 3 and its support bases with wheel 4, are seen, as well as the external profile 7 and internal profile 8 mounted on each of the side walls 22 and 23 of the vehicle box.

The anchoring screws 15, not illustrated in the figure, are housed in the internal cavity 16 of the external profile 7 mounted on each side wall of the vehicle box. In total, at least three screws 15 are placed for anchoring the external profile 7, along the side walls 22 and 23 of the vehicle box.

The description and illustration of the preceding figures is applicable to the assembly and fixing of the external profile 7 and internal profile 8 mounted on the right side wall 23 of the vehicle box.

The scope of protection of the present patent application is defined, in addition to the variants of embodiment of the example illustrated above, by the claims detailed below.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A sliding lid with removable panels for utility vehicle boxes and similar of the type consisting of at least three rectangular sliding panels linked together by hinges, comprising a sliding front panel (1), a sliding and foldable intermediate panel (2), and a sliding and foldable rear panel (3); support bases with wheels (4) being fixed to the lower face of said front panel (1), said intermediate panel (2) and said rear panel (3) adjacent to their vertices; said support bases with wheels (4) comprises a hollow prismatic body (20) inside which a wheel (6) is mounted; said support bases with wheels (4) comprises respective lower blocks (21) able to guiding said panels during sliding; an external profile (7) formed by a plurality of internal ribs (18) and a horizontal wing (19) mounted on the upper edge of each side wall (22, 23) of the vehicle box; an internal profile (8) being joined to said external profile (7) by a socket defined by a cavity (11) formed at an end (10) of a horizontal wing (9) of said internal profile (8) in which a lateral rib (12) of the external profile (7) is housed; said internal profile (8) having a rolling channel (13) on which the wheels (6) of the support bases with wheel (4) rotate; said internal profile (8) having a drainage channel (14) having a “U” configuration.

2. The sliding lid with removable panels for utility vehicle boxes set forth in claim 1, wherein said the hollow prismatic body (20) that forms said support bases with wheel (4) is made of injected plastic material.

3. The sliding lid with removable panels for utility vehicle boxes set forth in claim 1, wherein said support bases with wheel (4) are fixed to said lower face of said front panel (1), said intermediate panel (2), and said rear panel (3) by screws (5).

4. The sliding lid with removable panels for utility vehicle boxes set forth in claim 1, wherein said external profile (7) and said internal profile (8) are made of extruded aluminum.

5. The sliding lid with removable panels for utility vehicle boxes set forth in claim 1, wherein said external profile (7) is anchored along each side wall (22, 23) of the vehicle box by a plurality of screws (15) housed in an internal cavity (16) of said external profile.

6. The sliding lid with removable panels for utility vehicle boxes set forth in claim 1, wherein said rolling channel (13) formed in said internal profile (8) comprises a cylindrical configuration.
